(19) United States
(12) Patent Application Publication
(10) Pub. No.: US 2007/0121165 A1
(43) Pub. Date: May 31, 2007

(54) Image processing apparatus, printer driver, printing system, and program

(75) Inventors: Mitsuhisa Ando, Minowa-machi (JP); Masaki Hyogo, Ueda-shi (JP); Yutaka Hisamatsu, Ueda-shi (JP); Hiroshi Wanibuchi, Shiojiri-shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 11/601,063

(22) Filed: Nov. 17, 2006

(30) Foreign Application Priority Data
Nov. 18, 2005 (JP) 2005-333762

(51) Int. Cl. G06F 15/00

(52) U.S. Cl. 358/3.01; 358/3.03; 358/1.9

(57) ABSTRACT

A first half-tone processing means 110 half-tone processes image data blocks using an error diffusion method. A second half-tone processing means applies a half-tone process for error value calculation on a leading portion of each image data block before the normal half-tone processing. Two error buffers store the error values output by the first half-tone processing means successively to the leading error values already stored by the second half-tone processing means. Two data buffers store the process result from the first half-tone processing means. The first half-tone processing means starts half-tone processing the image data blocks using the leading error values stored in the two error buffers.

The present application claims priority from Japanese Patent Application 2005-333762 filed on Nov. 18, 2005, which is incorporated by reference in it entirety.

### BACKGROUND OF THE INVENTION

1. Technical Field

The present invention relates to an image processing apparatus, a printer driver, a printing system, and a program for half-tone processing of image data using an error diffusion method.

2. Related Art

Error diffusion is commonly used for half-tone processing image data. Printing systems that print by synchronizing operation of the print head in the main scanning direction with the paper feed operation in the sub scanning direction are also known. When used for imaging processing of the print data output to this type of printer, error diffusion normally processes data in the main scanning direction one raster at a time, and error in the sub scanning direction is generally stored in a memory area called an error buffer for use when processing the next raster.

When printing multiple pages using an error diffusion process, print quality at the beginning of a page can be degraded by error values passed from the preceding page, and the error buffer is therefore typically cleared at each page break. However, clearing the error buffer when printing a paper tape such as roll paper can conversely reduce print quality. More specifically, clearing the error buffer at the page break when printing an image that extends over multiple pages can result in an unnatural dot distribution. To prevent this problem Japanese Unexamined Patent Appl. Pub. H10-329383 teaches a method of not initializing the error buffer at the page break when printing continuous images.

This problem of reduced image quality also occurs when generating print data that exceeds the capacity of the print data buffer that stores the output of the error diffusion process. This happens when alternating between two data buffers, for example, because the error buffer is cleared when switching the data buffer and because the dot data that is referenced by the error diffusion process changes. More specifically, while there is no problem when switching between a plurality of data buffers if the error buffer can be shared, when there is a one to one correlation between the data buffers and error buffers and error values cannot be passed between the buffers, there is an unavoidable drop in print quality as a result of the error buffer being initialized when the data buffer is changed.

### SUMMARY

An image processing apparatus, a printer driver, a printing system, and a program according to the present invention prevent a loss of image quality when switching between data buffers even when two data buffers are used alternately and the error buffer cannot be shared.

An image processing apparatus according to a first aspect of at least one embodiment of the invention has a first half-tone processing means for dividing image data into n image data blocks (where n is an integer and n≧1) and applying a half-tone process using an error diffusion method to each of the image data blocks; a second half-tone processing means for executing a half-tone process for error value calculation on a predetermined portion of data at the leading end part of each image data block before processing by the first half-tone processing means; an odd-numbered error buffer for storing error values generated by the first half-tone processing means from the image data block successively from the leading error values generated by the second half-tone processing means when processing odd-numbered image data blocks; an even-numbered error buffer for storing error values generated by the first half-tone processing means from the image data block successively from the leading error values generated by the second half-tone processing means when processing even-numbered image data blocks; an odd-numbered data buffer for storing the result of processing odd-numbered image data blocks by the first half-tone processing means; an even-numbered data buffer for storing the result of processing even-numbered image data blocks by the first half-tone processing means; and a data output means for switching and alternately outputting the process results stored in the odd-numbered data buffer and even-numbered data buffer as the processed data after half-tone processing. The first half-tone processing means starts half-tone processing the odd-numbered image data blocks and even-numbered image data blocks using the leading error values stored in the odd-numbered error buffer and even-numbered error buffer, respectively.

When outputting the half-tone processed data alternately from two data buffers, an odd-numbered data buffer and an even-numbered data buffer, a half-tone process for calculating error values is run before the normal half-tone process is applied to the image data blocks, the resulting leading error values are stored in the odd-numbered error buffer or the even-numbered error buffer, and the error buffers are therefore not cleared when the data buffers are switched (because the leading error values are already stored when the buffers are switched). More specifically, the first half-tone processing means can start the half-tone process using the leading error values calculated and passed by the second half-tone processing means (that is, using the leading error values that are already stored in the error buffer), and a drop in print quality when the buffers are switched can thus be avoided. The image data blocks can be in page units or other units used for printing, including band units (that is, the area that can be printed in one pass of the print head). More specifically, the image data can be divided for processing into image data blocks of a desirable size determined by how the data will be used after image processing and the image processing performance of the system.

Preferably, the second half-tone processing means applies the half-tone process for error value calculation to a predetermined portion of data at the leading end part of each image data block starting from the second of the n image data blocks when the image data is divided into a plurality of image data blocks.

It is not necessary to consider continuity to the preceding image data in the first of n image data blocks (because image quality loss is not a problem if processing starts with the error buffers initialized), and it is therefore not necessary to apply the process to the first image data block.

Yet further preferably, the image data comprises a plurality of rasters, and the predetermined portion of data at the leading end part of each image data block is the data for ten rasters or less.

If each image data block contains 360 rasters, the control load can be reduced to 10/360 or less compared with an arrangement in which the second half-tone processing means processes every (360) raster. While the processing load thus decreases as the number of rasters processed decreases, experience has shown that the predetermined number of rasters is preferably at least three.

Yet further preferably, the processed data is data for bidirectional printing; and the processed data stored in the odd-numbered data buffer is used for printing on the forward pass and the processed data stored in the even-numbered data buffer is used for printing on the return pass.

This aspect of the invention simplifies control because the process results stored in the two data buffers can be used directly for printing on the forward pass and printing on the return pass.

Yet further preferably, the image data contains multiple colors; the image processing apparatus further comprises a color conversion processing means for applying a color conversion process to the image data to determine the mixing ratio of the plural coloring agents by referencing two color processing lookup tables including a table for forward-pass printing and a table for return-pass printing; and the color conversion processing means executes the color conversion process by switching the color processing lookup table that is referenced for the odd-numbered image data blocks and the even-numbered image data blocks.

This aspect of the invention changes the color processing tables referenced for printing on the forward pass and on the return pass when the image data contains a plurality of colors, and color differences resulting from the different order in which ink is placed on the paper during forward-pass and return-pass printing can be eliminated.

Another aspect of at least one embodiment of the invention is a printer driver comprising the means of the image processing apparatus described above.

A printing system according another aspect of at least one embodiment of the invention has an image processing apparatus described above and a printer that prints bidirectionally.

A program according to another aspect of at least one embodiment of the invention causes a computer to function as the means of the image processing apparatus described above.

These aspects of the invention also prevent a drop in print quality when switching the data buffers when two data buffers are used alternately and the error buffer cannot be shared.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a block diagram of a printing system according to a preferred embodiment of the invention.

FIG. 2 shows the arrangement of the carriage.

FIG. 3 describes the operation of the carriage.

FIG. 4 is a flow chart describing the processes executed by the printer driver.

FIGS. 5A and 5B show an example of a color processing lookup table.

FIG. 6 is a flow chart of the color matching process.

FIGS. 7A and 7B describe the interpolation process.

FIGS. 8A-8C are a continuation of FIGS. 7A and 7B.

FIG. 9 describes the half-tone processing block.

FIG. 10 describes the half-tone process.

FIG. 11 describes handler switching.

FIGS. 12A and 12B are a continuation of FIG. 11.

FIG. 13 is a flow chart of a print job process.

FIG. 14 is a flow chart of the printing process for each band that is part of the print job process.

FIG. 15 is a continuation of the flow chart in FIG. 14.

FIG. 16 describes the half-tone process according to a second embodiment of the invention.

FIG. 17 describes the half-tone process according to a third embodiment of the invention.

### DESCRIPTION OF EMBODIMENTS

Preferred embodiments of an image processing apparatus, a printer driver, a printing system, and a program according to the present invention are described below with reference to the accompanying figures.

When outputting processed data alternately from two data buffers after finishing half-tone processing (error diffusion), the present invention prevents a drop in image quality when switching between buffers by applying the half-tone process for error diffusion before the normal half-tone process so that the error values are calculated first and are then used in the normal half-tone process. The present invention is described below using an example in which the means of the image processing apparatus according to the present invention are performed by as a printer driver that is installed in and runs on a computer, and the printing system of the invention includes this computer (host computer) and a printer. An inkjet printer is used as the printer by way of example only.

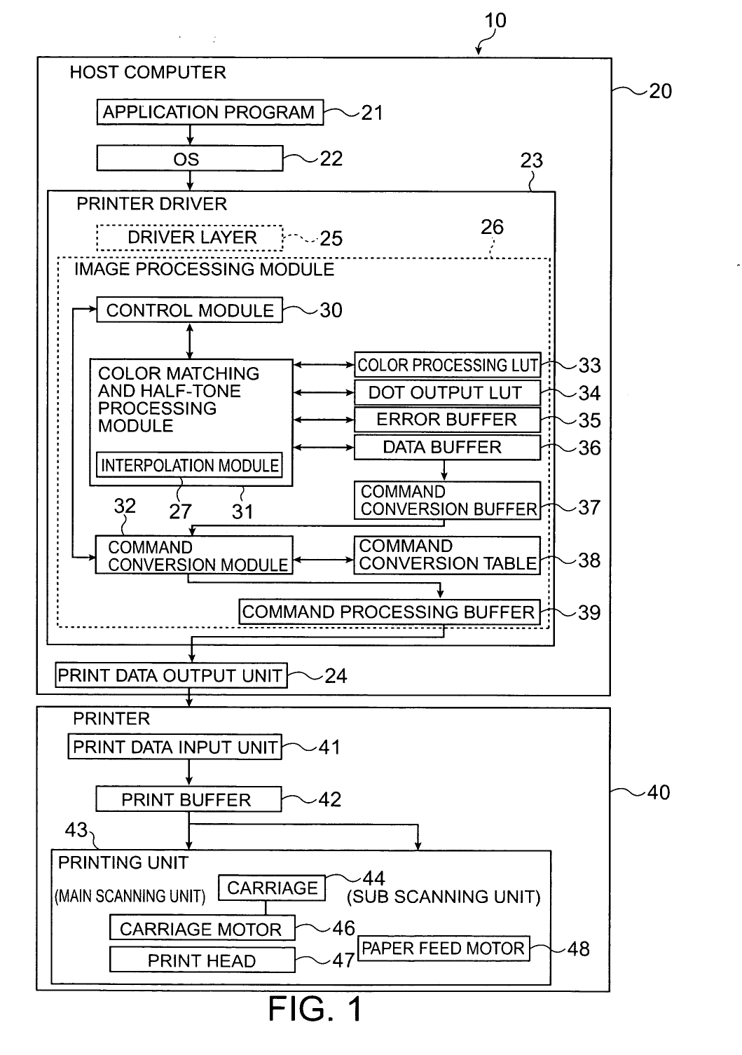

FIG. 1 is a block diagram of a printing system 10 according to a preferred embodiment of the invention. As shown in the figure the printing system 10 includes a host computer 20 and a printer 40. The host computer 20 stores and generates data, including producing the print data (ink discharge data) that is output to the printer 40 for printing.

The host computer 20 has an application program 21, an operating system (OS) 22, a printer driver 23, and a print data output unit 24. The application 21 is a program for creating the data (“image data” below) that requires half-tone processing (digitizing). The OS 22 is the basic program controlling host computer 20 operation. The printer driver 23 handles image processing, including color conversion processing and half-tone processing, and command conversion processing. The print data output unit 24 outputs print data (the processed data after image processing) to the printer 40.

The printer driver 23 includes a driver layer 25 that handles rendering and other processes, and an image processing module 26.

The image processing module 26 includes a control module 30, a color matching and half-tone module (color conversion processing means, first half-tone processing means, and second half-tone processing means) 31, and a command conversion module 32.

The control module 30 controls operation of the color matching and half-tone processing module 31 and command conversion module 32, and provides control complementing the functions of these modules 31 and 32.

The color matching and half-tone processing module 31 refers to a color processing look-up table (“LUT” below) (color processing LUT) 33 to apply a color matching process (color conversion process), and references a dot output LUT 34 to determine whether to output a dot of ink or other printing agent. This embodiment of the invention generates dots in four different sizes: non-printing dots (level 0), small dots (level 1), medium dots (level 2), and large dots (level 3). The printing density of each level can also be controlled. Additional dot sizes can also be defined for higher print quality. The color matching and half-tone processing module 31 also has an interpolation module 27 for interpolating values (by a process further described below) that are not present in the color processing LUT 33 during the color matching process.

The color matching and half-tone processing module 31 executes a half-tone process using an error diffusion technique, stores the error values produced by the half-tone process in an error buffer 35, and stores the digital data that is the output of the half-tone process in a data buffer 36. The data stored in the data buffer 36 is output in blocks of a predetermined size to a storage area called a command conversion buffer 37 for use in the following command process.

The command conversion module 32 references a command conversion table 38 while executing a process for converting commands to a format that can be understood by the printer 40, and outputs the data from this command conversion process to a command processing buffer 39.

The printer 40 includes a print data input unit 41, a print buffer 42, and a printing unit 43. The print data input unit 41 receives the print data output from the host computer 20, and the print buffer 42 temporarily stores the received print data. The printing unit 43 then reads the print data from the print buffer 42 and prints bidirectionally.

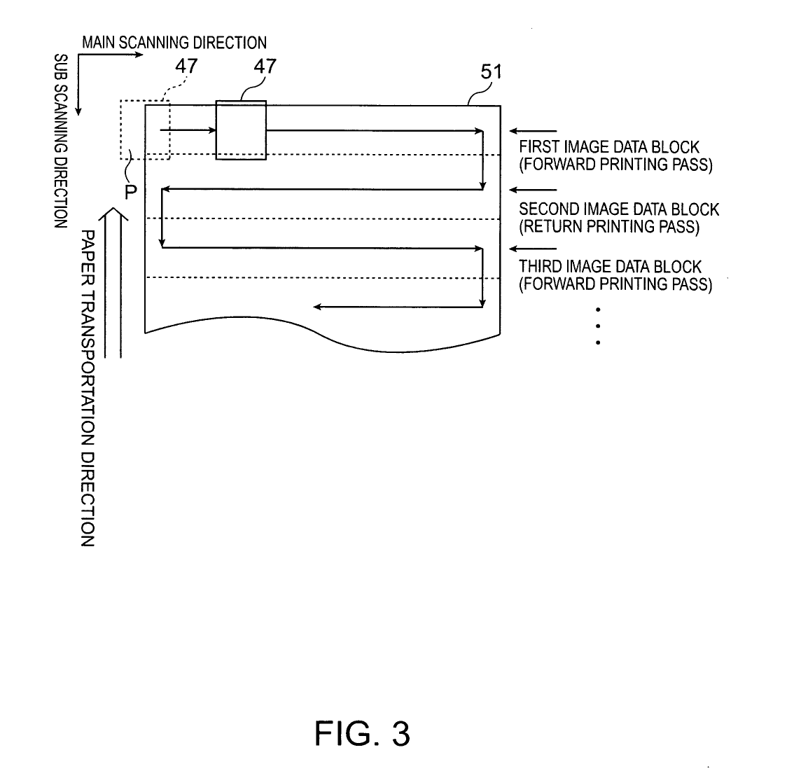

The printing unit 43 includes a carriage 44, a carriage motor 46, a print head (inkjet head) 47, and a paper feed motor 48. The carriage motor 46 drives the carriage 44 on which the print head 47 is mounted bidirectionally in the main scanning direction. The paper feed motor 48 conveys the print medium (paper) 51 (see FIG. 3) in the sub scanning direction. A desired image is printed on the print medium 51 by synchronizing driving the carriage motor 46 and paper feed motor 48 with the ink discharge operation of the print head 47.

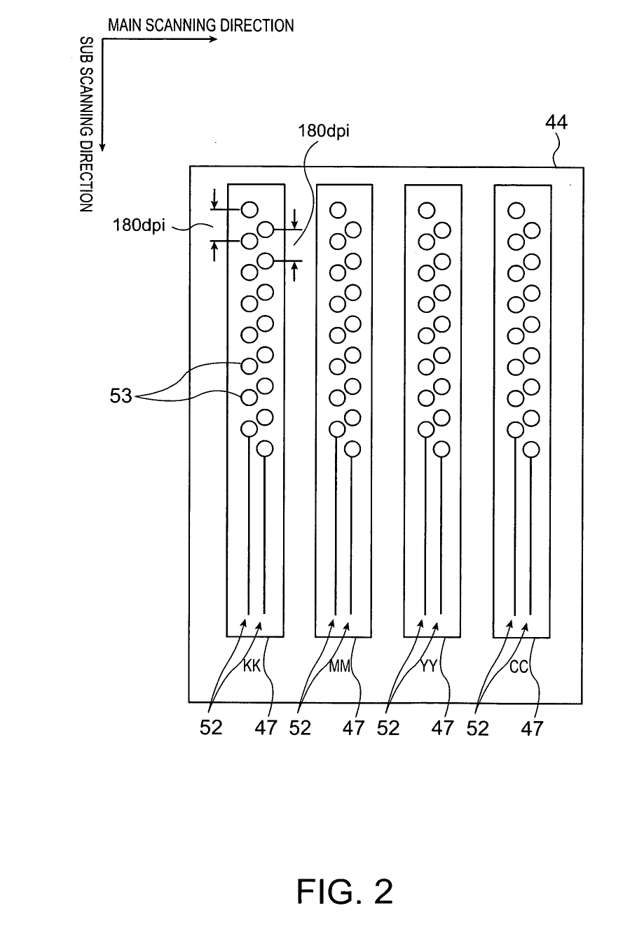

The arrangement of the carriage 44 (print head 47) is described next with reference to FIG. 2. FIG. 2 is a plan view of the carriage 44 as seen from the nozzle face, and the carriage 44 in this embodiment of the invention carries four print heads 47 including one each for K (black), M (magenta), Y (yellow), and C (cyan).

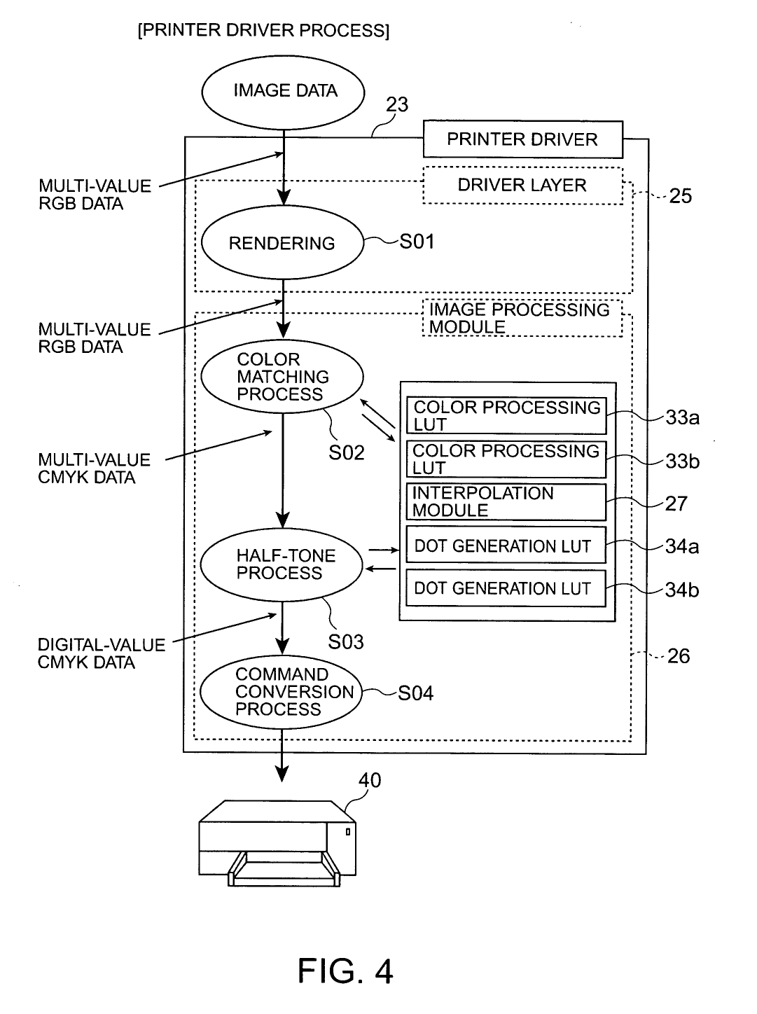

The print heads 47 are arrayed in the main scanning direction (the direction of carriage 44 movement) in the order K, M, Y, C. Ink is therefore discharged in the order K-M-Y-C on the forward (outward) pass, and in the order C-Y-M-K on the return pass. Because the ink is discharged in a different sequence on the forward pass and the return pass, ink is deposited on the print medium 51 in a different sequence and the colors that are produced on the forward and return passes differ. If the same image process (color conversion process) is applied for both printing directions, the colors produced on the forward pass will differ from the colors produced on the return pass. This embodiment of the invention therefore uses separate color processing LUTs 33a and 33b (see FIG. 4) to render the print data for the forward pass and the return pass, thereby preventing the color differences that result from differences in the order in which the ink is discharged (as described in detail further below).

Each print head 47 also has two nozzle rows 52 aligned in the sub scanning direction, and each nozzle row 52 has 180 nozzles 53 arrayed at a 180 dpi pitch. In addition, the two nozzle rows 52 in each print head 47 are offset so that there is a half dot offset between the nozzles 53 in adjacent rows and each print head 47 effectively has one row of nozzles 53 disposed at a 360 dpi pitch.

Operation of the carriage 44 is further described with reference to FIG. 3. FIG. 3 shows the relative positions of the print medium 51 and carriage 44, and the path of carriage 44 movement relative to the print medium 51 is denoted by the arrows. If the position P denoted by a dotted box in the figure is the printing start position (home position) P, the carriage 44 first prints while moving to the right in the main scanning direction. When printing to the right end of this forward pass ends, carriage 44 movement stops and waits for the paper to be fed forward in the sub scanning direction (toward the top of the page as seen in FIG. 3), and then continues printing while traveling to the left in the main scanning direction. When printing to the left end of the return pass ends, carriage 44 movement stops again and waits for the paper to be fed forward in the sub scanning direction, and then continues printing while traveling again to the right in the main scanning direction.

Printing proceeds by repeating these operations of printing in the main scanning direction and advancing the paper in the sub scanning direction, and for brevity printing while the carriage 44 moves to the right side in the main scanning direction is referred to below as “forward pass printing” and printing while the carriage 44 moves to the left in the main scanning direction is referred to as “return pass printing.” The image data printed in the area covered in one pass during forward pass printing or return pass printing is referred to as an “image data block.”

More specifically, the image data output by the application program 21 is divided by the printer driver 23 into n image data blocks (where n is an integer greater than or equal to 1), and the first block of image data (first image data block) is printed on the first forward printing pass. The second block of image data (second image data block) is then printed on the return printing pass, and the third block of image data (third image data block) is printed on the next forward printing pass. Odd-numbered blocks of image data are thus printed on the forward printing pass and even-numbered blocks are printed on the return printing pass. When printing all print data based on the image data (n blocks of image data) is completed, the carriage 44 is moved to the printing start position P and the printer waits for the next print command.

FIG. 4 schematically describes the processes and steps executed by the printer driver 23.

When the printer driver 23 gets the image data D output by the application program 21 (FIG. 1), the driver layer 25 renders the image data D (S01). Rendering is a process of converting information about objects and shapes described by numeric data to images by means of mathematical operations, and the rendering process is executed when the acquired image data contains such numeric data.

The image processing module 26 of the printer driver 23 then executes a color matching process (S02). This process uses the two color processing LUTs 33a and 33b for forward pass printing and return pass printing and the interpolation module 27 to convert multivalued RGB data to multivalued CMYK ink data.

The half-tone process (S03) runs after the color matching process ends. This half-tone process using an error diffusion technique is applied to each image data block based on the output of the color matching process and values read from the two dot generation LUTs 34a and 34b for forward pass printing and return pass printing.

If the content of the two dot generation LUTs 34a and 34b for forward pass printing and return pass printing is the same, it is also possible to provide only one table in the image processing module 26 for use printing in both directions. The content of the dot generation LUTs 34a and 34b for forward pass printing and return pass printing can also be different in order to further improve print quality.

When the half-tone process ends, a command conversion process (S04) is applied to the digital data output by the half-tone process (data denoting the four dot sizes, non-printing (level 0), small (level 1), medium (level 2), and large (level 3), or data denoting more than four dot sizes if even higher print quality is desired) and data output to the printer 40. Note that steps S02 to S04 are all executed by the image processing module 26.

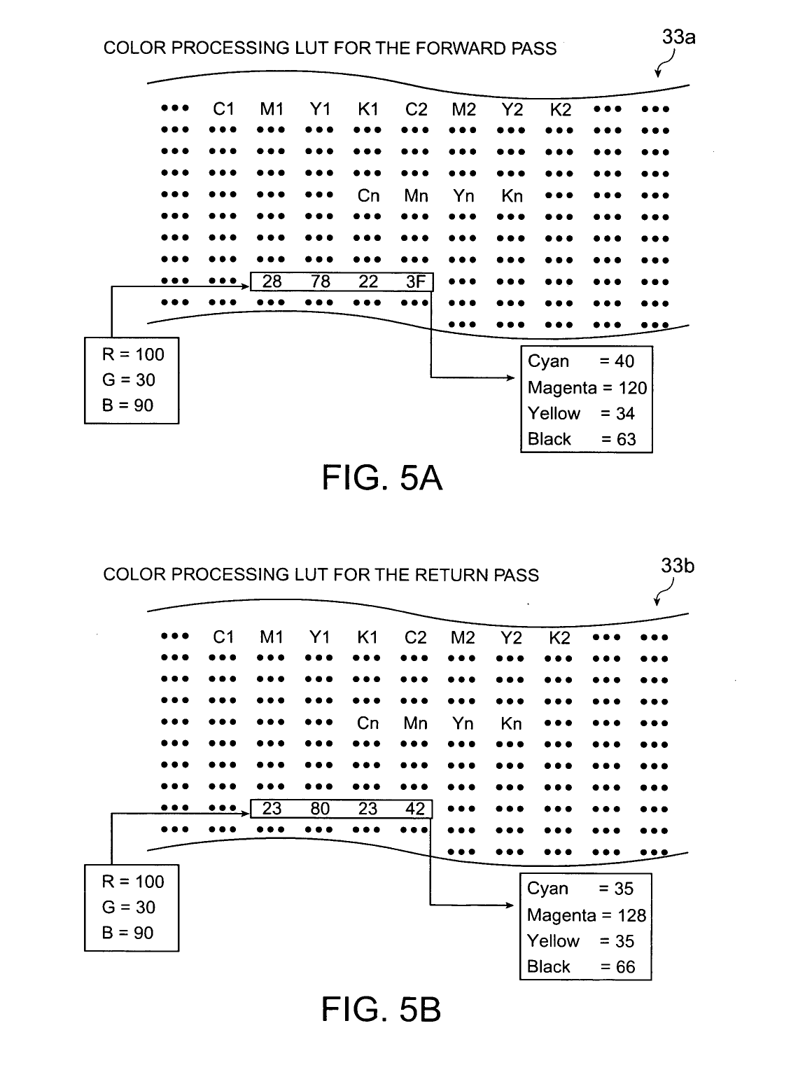

The color matching process (S02) is described in further detail with reference to FIG. 5 to FIG. 8.

FIGS. 5A and 5B show examples of the two color processing LUTs for processing the forward printing pass and the return printing pass (that is, forward printing pass color processing LUT 33a and return printing pass color processing LUT 33b). As noted above, the color processing LUTs 33a and 33b are color conversion tables for converting RGB data (additive color data) to CMYK data (subtractive color data), and blocks of 8-bit (0 to 255 in decimal) RGB data to blocks of 8-bit (0 to 255 in decimal) CMYK data. If higher image quality is desired, the resolution can be increased to work with 16 bits instead of 8 bits, for example. The color processing LUTs 33a and 33b are arrays of binary data ordered in CMYK sequence as shown in the figures (C1M1Y1K1, C2M2Y2K2, . . . CnMnYnKn).

However, it is not practical to include in the table all combinations of RGB data because there are 256ˆ3 (levels 0 to 255=256 levels) or approximately 16.77 million possible combinations. Specific RGB threshold values are therefore defined and only the corresponding CMYK values (values that determine how much ink is discharged) are recorded in the color processing LUTs 33a and 33b. As a result, if the RGB values are grouped in grids of 10, the color processing LUTs 33a and 33b are tables of 10³=1000 grids. The number of grids affects the precision of the output colors and a greater number of grids affords higher precision, but because more grids requires more storage capacity, the number of grids must be balanced with the intended product. FIG. 5A and FIG. 5B each show a part of color processing LUTs 33a and 33b.

For example, as shown in FIG. 5A, if the additive color ratio of a selected pixel in the image data to be printed on the forward pass (an odd-numbered image data block) is R=100, G=30, B=90 (decimal), and the corresponding subtractive color ratio (CMYK combination) is stored in the return pass color processing LUT 33a, the amount of ink discharged for each color is determined based on the corresponding CMYK ratio of C=40, M=120, Y=34, and B=63 (decimal).

Furthermore, if as shown in FIG. 5B the additive color ratio of a selected pixel in the image data to be printed on the return pass (an even-numbered image data block) is R=100, G=30, B=90 (decimal), and the corresponding subtractive color ratio (CMYK combination) is stored in the return pass color processing LUT 33b, the amount of ink discharged for each color is determined based on the corresponding CMYK ratio of C=35, M=128, Y=35, and B=66 (decimal).

When the additive color ratio is the same, the subtractive color ratios stored in the forward pass color processing LUT 33a and the return pass color processing LUT 33b are thus not necessarily the same. This is to prevent differences in the colors produced in the return printing pass and forward printing pass due to the difference in the order in which the colors are placed on a given dot (that is, discharging ink in the order K-M-Y-C on the forward pass and C-Y-M-K on the return pass as shown in FIG. 2 and FIG. 3).

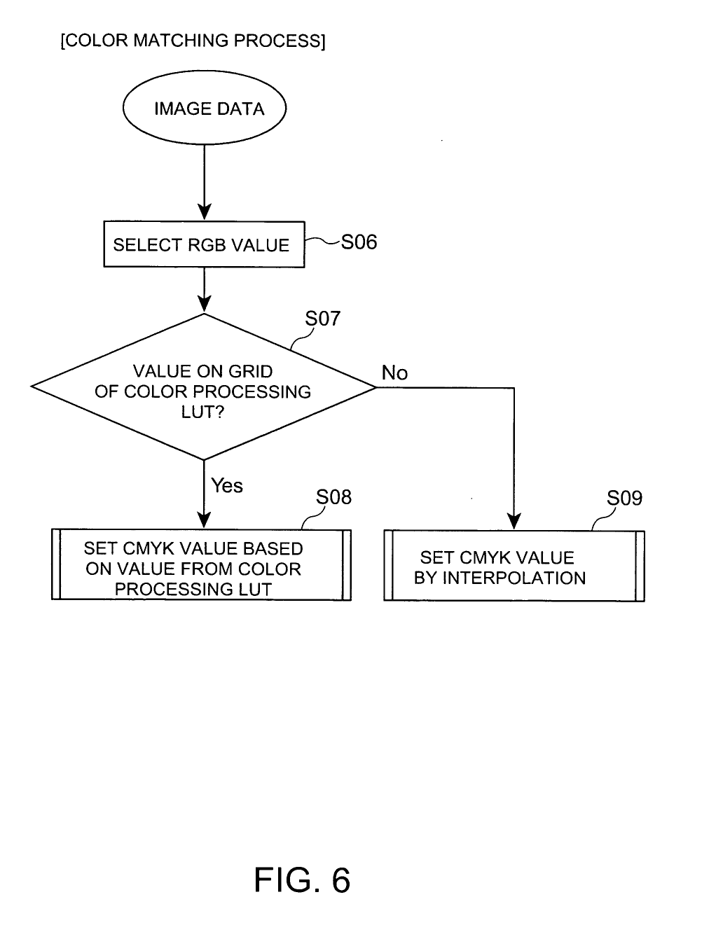

Furthermore, when the color processing LUTs 33a and 33b are grids of 1000 blocks as described above, the number of grids is less than the number required for actual data processing and the grid must be expanded to accommodate all possible RGB color value combinations. This embodiment of the invention uses an interpolation module 27 (see FIG. 4) to interpolate the CMYK values from the RGB values that are not on the grid. This is further described below starting with the color matching process of the color matching and half-tone processing module 31 shown in the flow chart in FIG. 6.

The color matching and half-tone processing module 31 determines (calculates) the RGB values (additive color ratio) based on the rendered image data (S06, additive color ratio calculation means). Whether the CMYK value corresponding to the RGB values are stored on the conversion grids of the color processing LUTs 33a and 33b is then determined (S07, color processing table lookup means). If the values are on the grid, that is, if CMYK values corresponding to the RGB values are on the grid as shown in FIGS. 5A and 5B (S07 returns Yes), the CMYK values are read from the color processing LUTs 33a and 33b (S08, subtractive color ratio determining means). If corresponding CMYK values are not on the grid (S07 returns No), the CMYK values are set (calculated) by the interpolation process of the interpolation module 27 (S09, subtractive color ratio determining means).

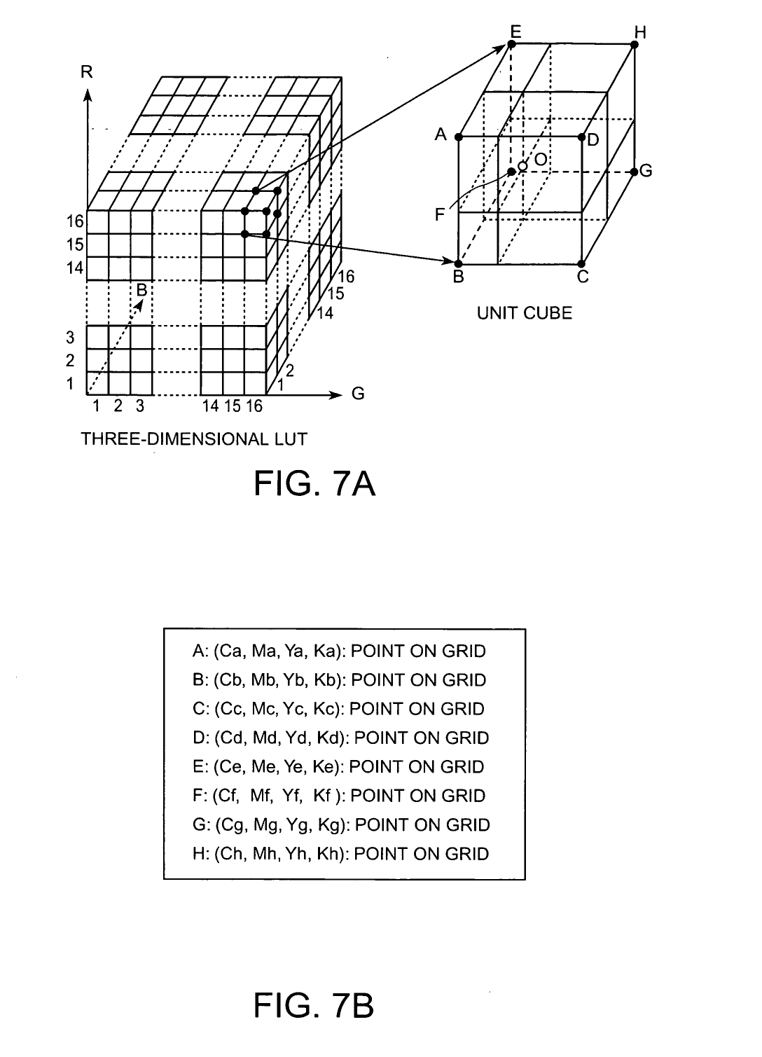

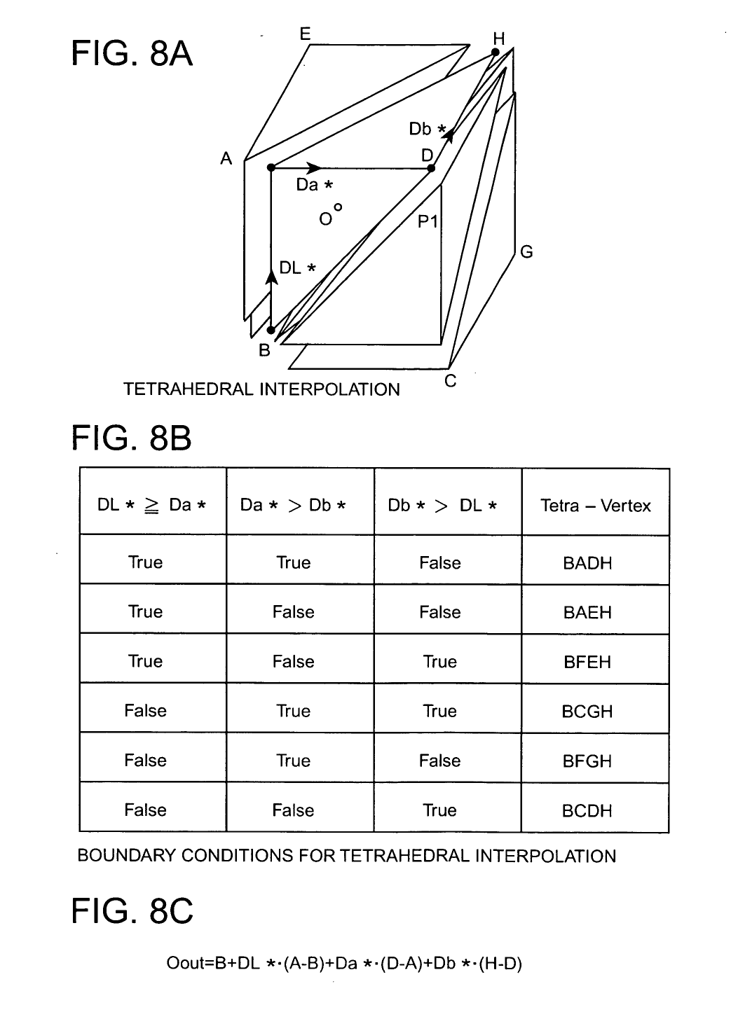

The principle of the interpolation process is described next with reference to FIGS. 7A and 7B and FIGS. 8A-8C. Tetrahedral interpolation is used in this embodiment. FIG. 7A shows the three-dimensional color processing LUTs 33a and 33b. When each of the RGB axes is divided into 16 parts as shown in the figure, a CMYK value is stored at each node of the mesh. If a particular RGB value is at point O in this three-dimensional coordinate space, there is a unit cube that contains point O with vertices A to H that are the output values of those nodes on the mesh, that is, the values on the grid (see FIG. 7B).

As shown in FIG. 8A, each unit cube is divided into six tetrahedrons, and the tetrahedron containing point O is determined from the boundary conditions shown in FIG. 8B. For example, if point O is in the domain indicated in FIG. 7A, that is, if
DL*≧Da*=True
Da*>Db*=True
Db*>DL*=False
and the region BADH contains point O (see the sloped portion in FIG. 8A), the CMYK value for RGB value O can be obtained from the equation shown in FIG. 8C.

Note that while tetrahedral interpolation is used in this example, other interpolation methods can be used instead, including cubic, prism, and hexahedral interpolation methods. In addition, the color processing LUTs 33a and 33b in this embodiment are described segmenting each of the RGB axes into ten grids, but the number of grids may be greater or less. The number of grids after expansion is also not limited to the approximately 16.77 million grids ((0 to 255=) 256×256×256) corresponding to all possible RGB combinations, and may be less or greater if the interpolation process is applied multiple times to the input RGB values.

The spacing of the grids in the color processing LUTs 33a and 33b can be uniform or irregular based on an experiential rule. The grid spacing or the number of grids can also be different in each color processing LUT 33a and 33b.

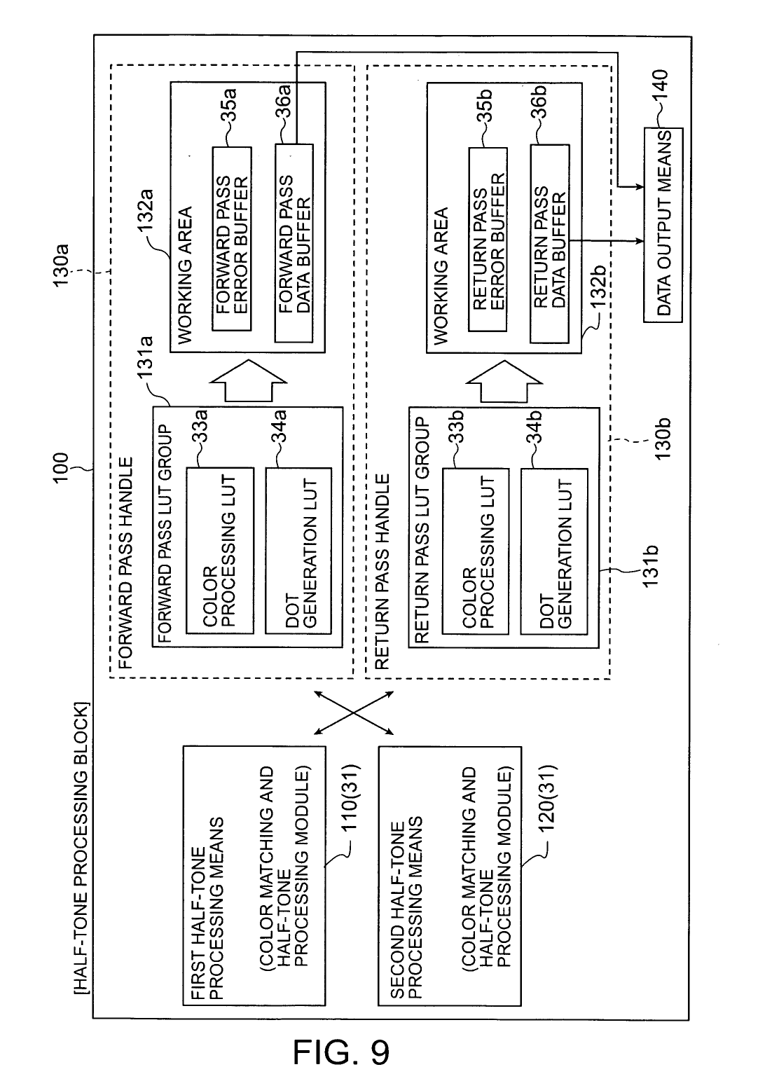

The half-tone process (step S03 in FIG. 4) is described in further detail next with reference to FIG. 9 to FIG. 12. FIG. 9 is a block diagram schematically describing the elements of the half-tone processing block used in the half-tone conversion process. As shown in the figure the half-tone processing block 100 includes two half-tone processing means 110 and 120, two handles 130a and 130b, and a data output means 140 for outputting the processed data to the next process after the half-tone process ends.

The half-tone processing means 110 and 120 are both main components of the color matching and half-tone processing module 31 (see FIG. 1) for executing a half-tone process using an error diffusion method. The first half-tone processing means 110 applies a normal half-tone process to image data blocks derived by segmenting the image data into n parts. The second half-tone processing means 120 applies a half-tone process for error diffusion (also referred to as “overlapping” below) to a specific portion of data at the beginning of each image data block.

The two handles 130a and 130b include LUT groups 131a and 131b and working areas 132a and 132b, respectively. Handle 130a is the forward pass handle that is used for processing the image data blocks that are printed on the forward pass (that is, odd-numbered image data blocks (see FIG. 3), referred to below as “forward pass image data”), and handle 130b is the return pass handle that is used for processing the image data blocks that are printed on the return pass (that is, the even-numbered image data blocks (see FIG. 3), referred to below as “return pass image data”).

The forward pass LUT group 131a includes forward pass color processing LUT 33a and forward pass dot generation LUT 34a, and is used for half-tone processing forward pass image data.

The return pass LUT group 131b similarly includes return pass color processing LUT 33b and return pass dot generation LUT 34b, and is used for half-tone processing return pass image data.

The forward pass working area 132a includes a forward pass error buffer (odd-numbered error buffer) 35a and a forward pass data buffer (odd-numbered data buffer) 36a that respectively store the error values generated from the half-tone process applied to the forward pass image data and the result of the half-tone process on the forward pass image data.

The return pass working area 132b similarly includes a return pass error buffer (even-numbered error buffer) 35b and a return pass data buffer (even-numbered data buffer) 36b that respectively store the error values generated from the half-tone process applied to the return pass image data and the result of the half-tone process on the return pass image data.

The data output means 140 switches alternately between the processing results stored in the forward pass data buffer 36a and the return pass data buffer 36b and outputs to the command conversion buffer 37 (see FIG. 1).

The basic operation run by the half-tone processing block 100 is described below.

When the half-tone processing block 100 acquires the first image data block (forward pass image data), the first half-tone processing means 110 first references the forward pass LUT group 131a and applies the half-tone process raster by raster. The error values resulting from this half-tone process are stored in the forward pass error buffer 35a, and the digital data resulting from the process is stored in the forward pass data buffer 36a. Because the nozzle rows 52 for each color contain 360 nozzles 53 as shown in FIG. 2, each image data block contains data for the 360 rasters corresponding to each of the nozzles for each color. The half-tone process is thus applied to a 360-raster unit of data. Note that while this embodiment assumes that all nozzles for every color are used to print the image data blocks, the invention is obviously not so limited and the number of rasters in each image data block can be a value less than the number of nozzles of each color.

In general (conventionally), half-tone processing the second image data block starts when half-tone processing the 360-raster portion of the first image data block ends.

With the present invention, however, the second half-tone processing means 120 references the return pass LUT group 131b and simultaneously starts half-tone processing of the second image data block when processing of the last three rasters of the first image data block starts. More specifically, once processing of the second image data block starts, half-tone processing of the remaining three rasters of the first image data block by the first half-tone processing means 110 and half-tone processing of the first three rasters following in the second image data block by the second half-tone processing means 120 proceed simultaneously, that is, processing overlaps. Note, however, that the second half-tone processing means 120 does not process any part of the image data block (i.e., the first image data block) processed by the first half-tone processing means 110 because processing the first image data block does not need to consider continuity with the preceding image data (i.e., image quality loss is not a problem even if operation starts with the error buffers 35a and 35b initialized).

The error values of the second image data block generated by the second half-tone processing means 120 (referred to below as “leading error values”) are stored to the return pass error buffer 35b, but the binary data resulting from the process is not used (because the data is stored to the return pass data buffer 36b but is overwritten by the process results output by the first half-tone processing means 110). More specifically, the first half-tone processing means 110 sequentially half-tone processes the image data blocks, but the second half-tone processing means 120 executes the half-tone process only to calculate the leading error values for the next image data block to be processed by the first half-tone processing means 110 before the first half-tone processing means 110 processes the data.

When the second half-tone processing means 120 finishes processing the second image data block, the first half-tone processing means 110 references the return pass LUT group 131b due to the change in the printing direction and starts half-tone processing the second image data block. Because the leading error values calculated by the second half-tone processing means 120 are already stored in the return pass error buffer 35b, the first half-tone processing means 110 uses these leading error values when starting half-tone processing the second image data block. When the first half-tone processing means 110 starts processing the last three rasters of the second image data block, the second half-tone processing means 120 starts processing the first three rasters of the third image data block. The two half-tone processing means 110 and 120 thereafter repeat this process until the n-th image data block is processed.

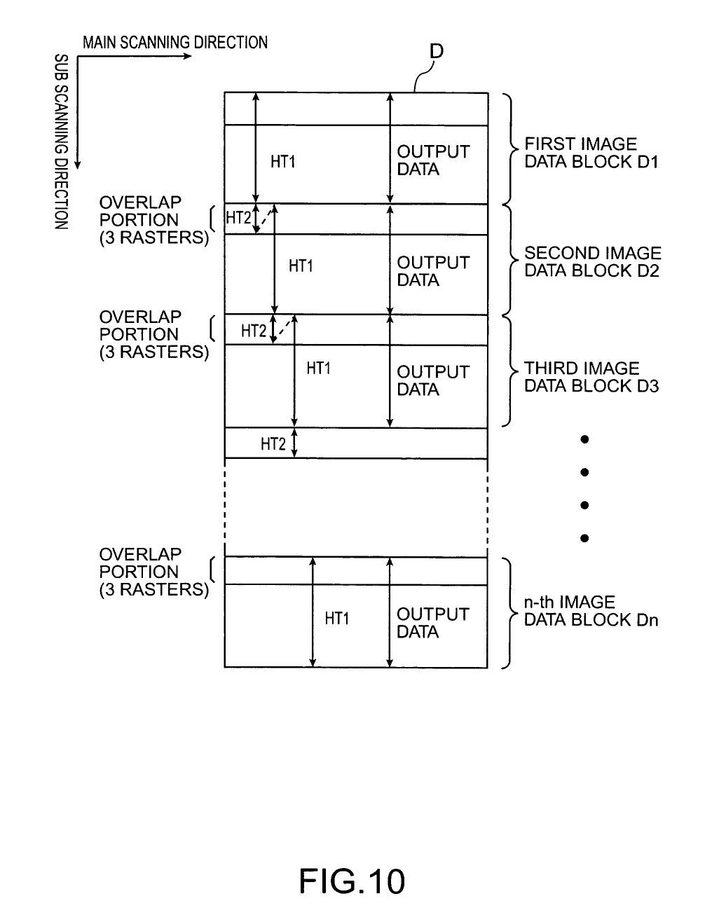

FIG. 10 illustrates the process run by the two half-tone processing means 110 and 120. The image data is denoted D and the image data blocks are denoted D1 to Dn. As described above, the half-tone processing block 100 outputs the half-tone processed image data for each of the n image data blocks D1, D2, to Dn into which the image data D is divided (denoted “output data” in the figure), but in the second and subsequent image data blocks, half-tone processing (HT1, HT2 in the figure) overlaps at the beginning (the first three rasters) of each image data block. More specifically, the second half-tone processing means 120 processes the three rasters of data denoted HT2 in the figure, and the first half-tone processing means 110 processes the 360 rasters of data in the image data blocks denoted HT1 using the error values output by the second half-tone processing means 120.

Because no image data follows the last image data block (the n-th image data block Dn), processing the last three rasters of the n-th image data block is handled by the first half-tone processing means 110 alone (there is no overlap processing by the second half-tone processing means 120).

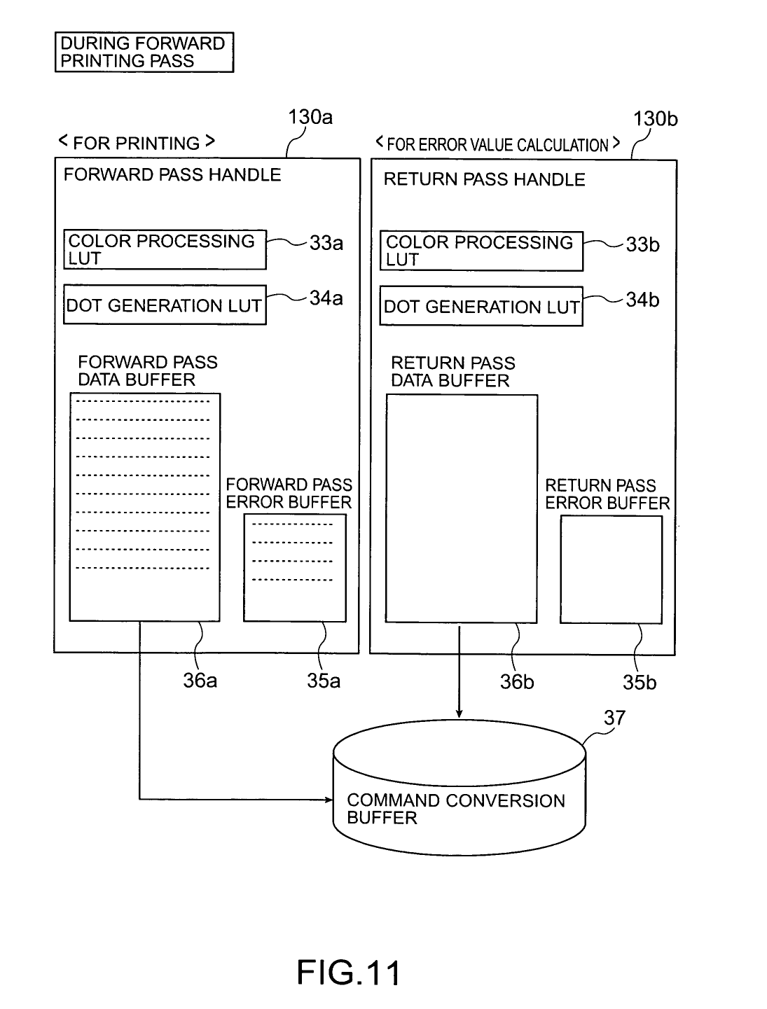

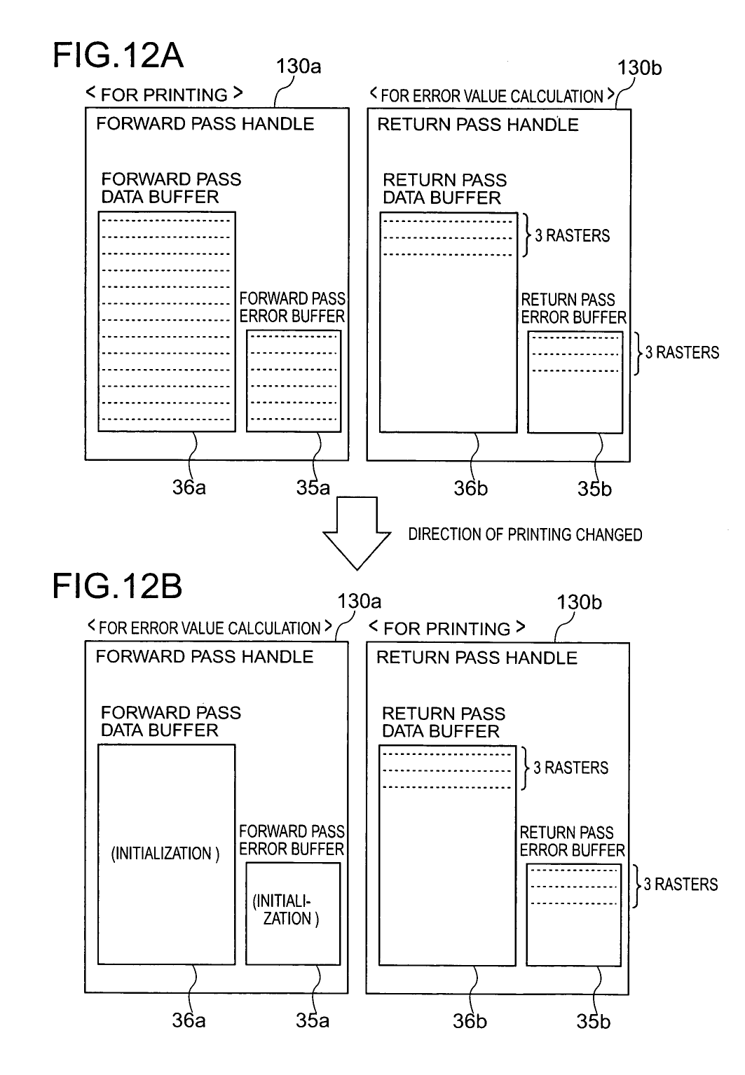

Switching between the forward pass handle 130a and return pass handle 130b shown in FIG. 9 is described in further detail below referring to FIG. 11 and FIGS. 12A and 12B. As shown in FIG. 11 and assuming printing on the forward pass, the forward pass handle 130a functions for printing and the return pass handle 130b functions for error value calculation. More specifically, the first half-tone processing means 110 uses the forward pass handle 130a and the second half-tone processing means 120 uses the return pass handle 130b. In the example shown in the figure, the forward pass image data is being half-tone processed and operation has not reached the last three rasters. The return pass handle 130b is therefore not functioning yet and the return pass data buffer 36b and return pass error buffer 35b are in the initialized state (that is, they store no data). When the data in the forward pass data buffer 36a reaches a predetermined level (such as equal to a 32 raster portion of data), the processed binary data is output to the command conversion buffer 37. After the processed data for all rasters in the forward pass image data is output, the handles 130a and 130b are switched so that the forward pass handle 130a is used for error values calculation and the return pass handle 130b is used for printing.

Note that data buffers 36a and 36b output data when the data reaches a predetermined level and buffer capacity can therefore be set as desired, but the error buffers 35a and 35b require the capacity to store three rasters of leading error values and the error values for one full band of print data (equal to 360 rasters in this embodiment of the invention).

FIGS. 12A and 12B describe the initialization timing of the error buffers 35a and 35b. During the forward printing pass, for example, forward pass handle 130a is used for printing and return pass handle 130b is used for error value calculation as described above, and when the first half-tone processing means 110 finishes processing all rasters in the forward pass image data, the buffer states are as shown in FIG. 12A. That is, the error values for all 360 rasters in the forward pass image data are written to the forward pass error buffer 35a, and the leading error values for the first three rasters in the next image data block are stored in the return pass error buffer 35b.

When the direction of printing changes, the data processed and written to the forward pass data buffer 36a by the first half-tone processing means 110 is output to the command conversion buffer 37, and the function of the handles 130a and 130b is switched. FIG. 12B shows the states of the buffers after the printing direction is changed. As shown in FIG. 12B, when the forward pass handle 130a is switched for use calculating the error values, the forward pass data buffer 36a and forward pass error buffer 35a are initialized. While the processed data for three rasters and the error values are stored to the data buffer 36b and error buffer 35b of the return pass handle 130b, the data in the return pass data buffer 36b is overwritten by the results of processing the return pass image data. More specifically, the data processed and output by the second half-tone processing means 120 is not used. The forward pass data buffer 36a can therefore be initialized when switched for use calculating the error values. The error values stored in the return pass error buffer 35b remain in memory, and the first half-tone processing means 110 starts half-tone processing the return pass image data using the error values in the return pass error buffer 35b. As a result, the error values for the first raster processed when the return pass handle 130b is used for printing are written to the fourth raster in the return pass error buffer 35b.

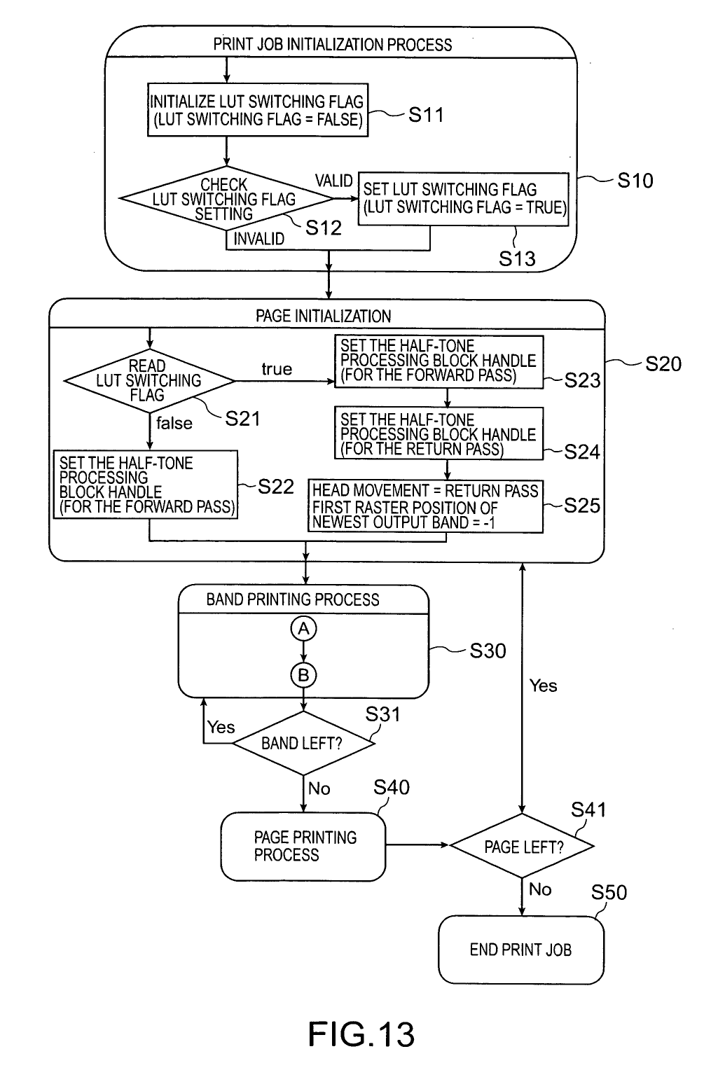

Print job processing by the printer driver 23 (particularly the image processing module 26, see FIG. 1) is described next with reference to the flow charts in FIG. 13 to FIG. 15.

As shown in FIG. 13, the main steps in processing a print job are print job initialization (S10), page initialization (S20), printing each band (the area that can be printed in one pass of the print head 47 in the main scanning direction) (S30), finishing each page (S40), and finishing the print job (S50).

The first step in print job initialization (S10) is to initialize the LUT switching flag (S11). This LUT switching flag is set to TRUE when switching the color processing LUTs 33a and 33b for printing on the forward pass and the return pass. This flag can be enabled or disabled (set to TRUE or FALSE) using a graphical user interface (GUI) provided by the printer driver 23, but is set according to the print mode (a mode that can be set by the user according to the print quality or print medium) in this example. More specifically, if there are print modes A to D, for example, the LUT switching flag is TRUE when mode A or B is selected and the LUT switching flag is FALSE when mode C or D is selected. Therefore, after the LUT switching flag is initialized (S11), the LUT switching setting of the print mode is read (S12), and if the LUT switching flag is enabled (S12 returns VALID), the LUT switching flag is set to TRUE (S13).

In the page initialization step (S20), the LUT switching flag is read (S21), and if the LUT switching flag is invalid (S21 returns FALSE), only the forward pass handle 130a of the half-tone processing block 100 (FIG. 9) is selected (S22). In this case the forward pass handle 130a is used for both forward pass and return pass printing, and the handles 130a and 130b are not switched. The second half-tone processing means 120 also does no half-tone processing for error value calculation, and the first half-tone processing means 110 uses the forward pass handle 130a to process all image data blocks.

If the LUT switching flag is read (S21) and is valid (S21 returns TRUE), the two handles 130a and 130b of the half-tone processing block 100 are selected for forward pass printing and return pass printing (S23, S24), the direction of print head 47 movement to this point is set to the “return pass,” and the starting raster position of the newest output band is set to −1 (S25). The starting raster position is initialized to −1 because the print head 47 always travels in the forward direction when printing the first image data block D1 (the print head 47 moves from printing start position P to the right in the main scanning direction as seen in FIG. 3), the direction of print head 47 movement switches after each printing pass, and if the direction of print head 47 movement before the first printing pass is defined it must be set to the “return pass” (this also applies when a blank line is skipped before starting printing to the print medium 51). As a result, the step of determining the beginning of a page can also be omitted. The starting raster position of the newest output band is also set to −1 to initialize the page (so that the raster position to be processed next is the first raster in the output band).

The first step in the band printing process (S30) is to determine if any bands are left (S31), and if there are (S31 returns Yes) to repeat the band printing process (S30). If no bands are left (S31 returns No), the page is ended (S40) and whether any pages are left is determined (S41). If there is another page to print (S41 returns Yes), the page initialization step (S20) repeats. If there are no more pages to print (S41 returns No), the print job is ended (S50).

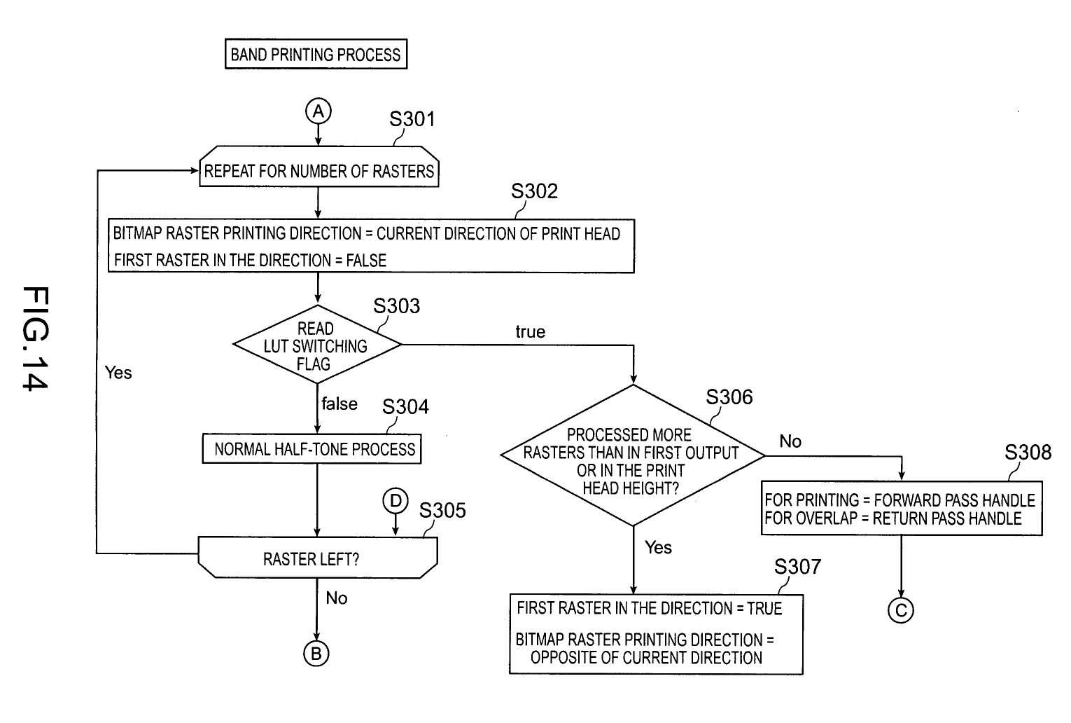

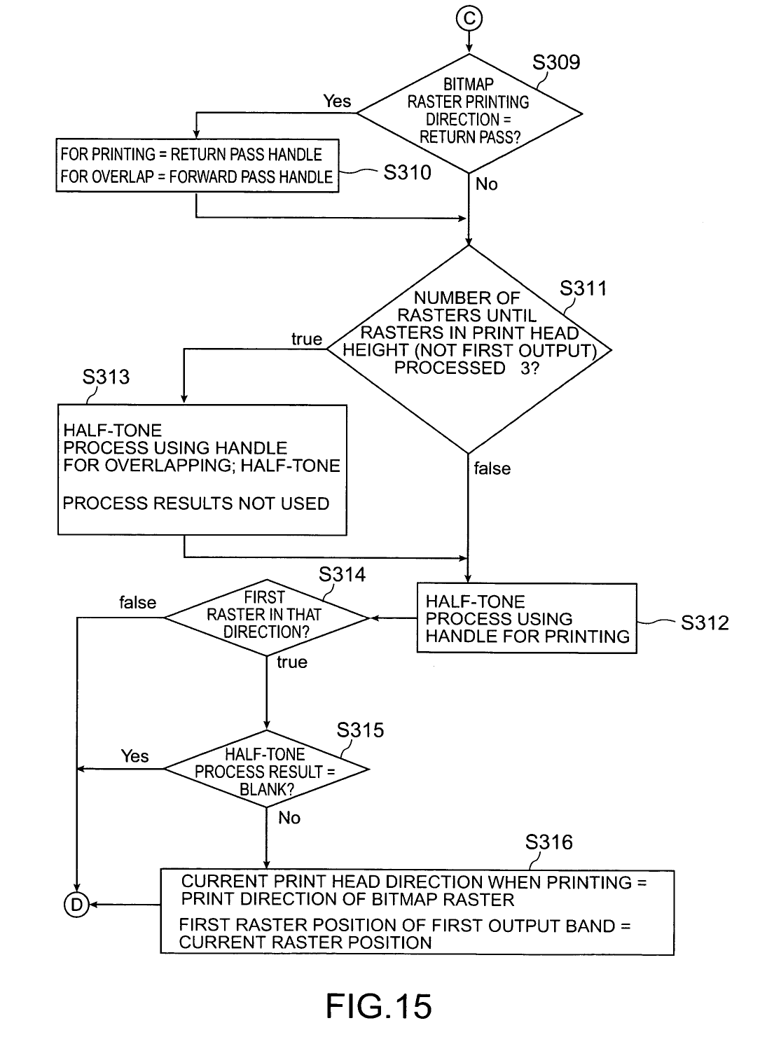

The band printing process (S30) is described further below referring to the flow chart shown in FIG. 14 and FIG. 15. As shown in FIG. 14, the band printing process repeats for each of rasters in the bitmap of the image data (S301). The direction in which the bitmap raster is printed is the direction of print head travel while printing to this point, that is, the return pass (see FIG. 13, S25), where the raster is not the first raster in that direction (S302).

The LUT switching flag is then read (S303) and if the LUT switching flag is not valid (S303 returns FALSE), the normal half-tone process is executed (S304). More specifically, the same decision made in steps S12 and S21 in FIG. 13 is made, and if switching the LUTs is turned off, the half-tone process is run using only the forward pass handle 130a. Whether any rasters are left is then determined (S305), and if there are (S305 returns Yes), the process repeats from step S301. If no rasters are left (S305 returns No), the band printing process (S30) ends.

If the LUT switching flag is valid (S303 returns TRUE), whether a number of rasters equal to or greater than the number of rasters in the first output or in the height of the print head 47 (360 rasters in this example) were processed is determined (S306). This embodiment of the invention uses the number of rasters in the height of the print head 47 (360 rasters), but as described above in the raster structure of the image data blocks, the number of rasters in this print head height can be less than or equal to the number of nozzles in the print head 47. In this case, printing proceeds without using all nozzles of the print head 47 (that is, using only some of the nozzles). If the first raster in the band is printing (S306 returns Yes), the raster is the first raster in that printing direction, and the printing direction of the bitmap raster is opposite to the printing direction to this point (the return pass, see S302), that is, the forward pass (S307). The printing direction at this stage is hypothetical, however, and the actual printing direction is determined in the downstream step S316 (see FIG. 15).

The handle of the half-tone processing block 100 for printing is then set to the forward pass handle 130a and the handle of the half-tone processing block 100 for overlapping (for error value calculation) is set to the return pass handle 130b (S308). The first half-tone processing means 110 thus uses the forward pass handle 130a, and the second half-tone processing means 120 uses the return pass handle 130b. Note that if step S306 returns No, the direction of the print head 47 has not changed, step S307 is omitted, and step S308 executes.

Whether the printing direction of the bitmap raster is the “return pass” is then determined (S309). If the raster is the first raster in the band, S309 returns No because the “forward pass” is set in step S307. If the printing direction of the raster is the return pass, the handle of the half-tone processing block 100 for printing is the return pass handle 130b and the handle of the half-tone processing block 100 for overlap processing is the forward pass handle 130a (S310).

Whether the number of rasters left until the number of rasters in the print head height have been processed (not the first output) is less than or equal to the number of rasters in the overlap region (that is, three rasters) is then determined (S311). If, for example, the raster is the first raster in the band, FALSE is returned because the raster is the first output, and the half-tone process is run using the handle of the half-tone processing block 100 for printing (S312). Step S312 is therefore run by the first half-tone processing means 110. If step S311 returns TRUE, the half-tone process is executed using the handle of the half-tone processing block 100 for overlapping (S313). In this case, step S312 is run by the second half-tone processing means 120 and the result of the process is not used (the data is written to data buffers 36a and 36b but is then overwritten). If step S311 returns TRUE, step S312 is run simultaneously by the first half-tone processing means 110 for printing and the second half-tone processing means 120 for overlapping.

Whether the raster is the first raster in that printing direction is then determined (S314). If it is the first raster in the printing direction (such as the first raster in the band) (S314 returns TRUE), whether the half-toning result is blank or not is determined (S315). Whether the half-toning result is a blank raster or not is determined because valid pixels are sometimes output where the result of the half-tone process is a blank raster. If the result of the half-tone process is not a blank raster because there are valid dots to be printed (S315 returns No), the direction of print head movement is set to the printing direction of the bitmap raster, the first raster position in the most recent (the preceding) output band is reset to the current raster position (S316), and control returns to step S305 (FIG. 14). Note that the direction of print head movement that is set in step S316 is the direction set hypothetically in step S307 (FIG. 14), that is, the forward pass.

If step S314 returns FALSE because the current raster is not the first raster, checking for a blank raster (S315) is not necessary and control therefore returns directly to step S305 to avoid unnecessary steps. If step S315 returns Yes because there is a blank raster, step S316 is omitted and operation returns to step S305.

This embodiment of the invention as described above eliminates color inconsistencies caused by a difference in the printing direction by referencing a forward pass color processing LUT 33a and a return pass color processing LUT 33b in the color matching process applied to forward pass image data and return pass image data and constructing the color processing LUTs to eliminate such color shifts based on experimental values. Furthermore, color processing LUTs 33a and 33b containing a very large number of color conversion patterns also need not be used because values that are not contained in the color processing LUTs 33a and 33b are interpolated by the interpolation module 27.

Unnecessary processing is also eliminated because the interpolation module 27 runs the interpolation process only when the CMYK value corresponding to a particular RGB is not found in the color processing LUTs 33a and 33b, and when the desired CMYK value is in the color processing LUTs 33a and 33b, the value retrieved from the lookup table is used to determine the ink discharge volume.

In addition, the size of the color processing LUTs 33a and 33b can be determined according to the memory capacity (the capacity for storing the color processing LUTs 33a and 33b) and the control capacity (to control the interpolation process) of the system. More specifically, if storage capacity is unlimited, the control load can be reduced by increasing the size of the color processing LUTs 33a and 33b, but the size of the color processing LUTs 33a and 33b can be reduced if a high performance CPU is used.

Furthermore, the error buffers 35a and 35b are not cleared when the data buffers 36a and 36b are switched because the half-tone process for error value calculation is run and the resulting leading error values are stored in the forward pass error buffer 35a or return pass error buffer 35b before the normal half-tone process is applied to the forward pass image data or return pass image data during half-tone processing. More specifically, if the error diffusion process starts when the direction of the print head 47 changes, there will be a noticeable delay in dot generation because the error values are cleared, but undesirable color irregularities in the printed image can be prevented because the first half-tone processing means 110 starts the half-tone process using the leading error values already calculated by the second half-tone processing means 120 (that is, using the leading error values stored in the error buffers 35a and 35b). A drop in print quality can thus be prevented even when switching between two data buffers 36a and 36b that are alternately used for forward pass printing and return pass printing.

Furthermore, because the half-tone process run by the second half-tone processing means 120 for error value calculation only processes three rasters at the leading edge of each image data block, the processing load of the second half-tone processing means 120 is 1/120 ( 3/360) of the load when the second half-tone processing means 120 process all (360) rasters in the printing pass.

Yet further, by using two separate data buffers 36a and 36b for printing on the forward pass and the return pass, switching between which of the data buffers 36a and 36b is used can be synchronized to the change in the printing direction, and control is thus also simple.

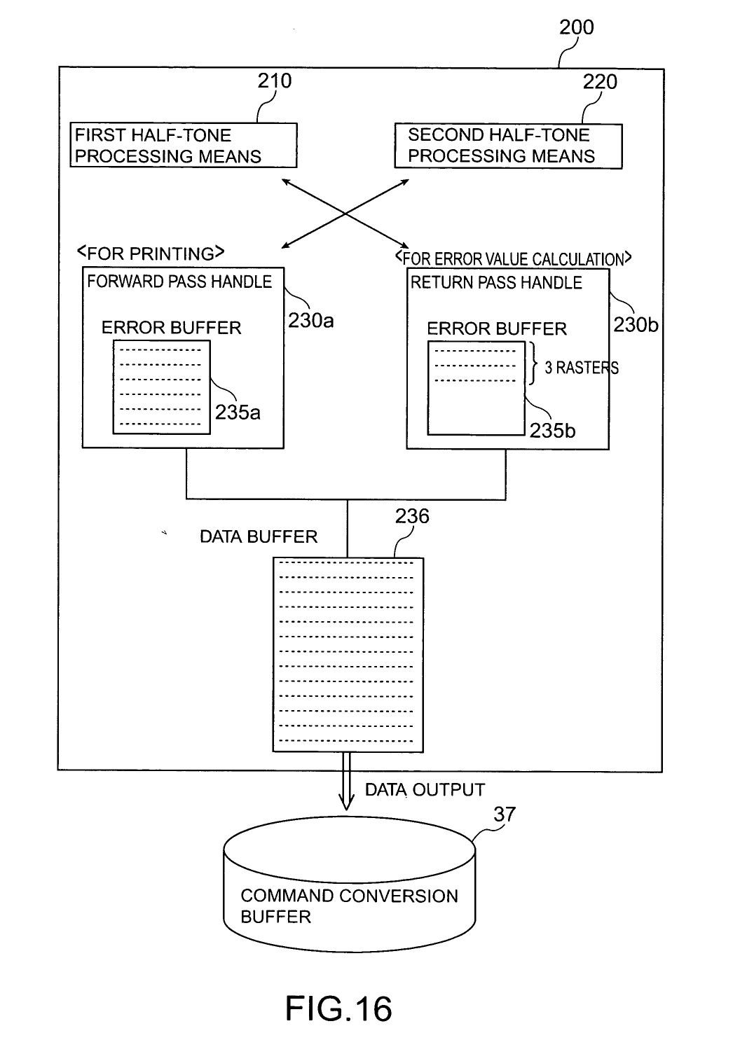

A second embodiment of the invention is described next with reference to FIG. 16. The first embodiment uses two data buffers 36a and 36b in the half-tone process for the forward printing pass and the return printing pass as described in FIG. 11. This second embodiment differs from the first embodiment by using only one data buffer 236. Primarily the differences between the first embodiment and this second embodiment are described below.

As shown in FIG. 16 the half-tone processing block 200 in this embodiment of the invention includes a first half-tone processing means 210 for executing the normal half-tone process, a second half-tone processing means 220 for running a half-tone process for error value calculation, and two handles 230a and 230b. This embodiment is the same as the first embodiment in that the first half-tone processing means 210 and the second half-tone processing means 220 switch handles 230a and 230b, and the handles 230a and 230b each have an error buffer (odd-numbered buffer and even-numbered buffer) 235a and 235b. Also similarly to the first embodiment, separate color processing LUTs 33a and 33b and dot generation LUTs 34a and 34b can be rendered in the handles 230a and 230b, or the first half-tone processing means 210 and second half-tone processing means 220 can reference a common color processing LUT and dot generation LUT.

The process executed by the half-tone processing block 200 in this embodiment of the invention is described below.

When the half-tone processing block 200 receives the first partial image data block (forward pass image data) from the color matching process, the first half-tone processing means 210 first runs the normal half-tone process and writes the error values from this process to the error buffer 235a in the forward pass handle 230a. The output of the first half-tone processing means 210 is stored in data buffer 236.

When processing of the last three rasters (raster 358) in the first image data block starts, the second half-tone processing means 220 simultaneously starts the half-tone process to calculate error values for the second image data block. The results from this operation (the leading error values) are stored to the error buffer 235b of the return pass handle 230b, and the process result is stored to another storage area not shown. The second half-tone processing means 220 also stores the result of processing three rasters in this other storage area, but the stored content is sequentially overwritten and is not particularly used.

When the first half-tone processing means 210 finishes processing the first image data block, the first half-tone processing means 210 starts processing the second image data block using the error values for the three rasters already stored in the error buffer 235b of the handle 230b when the printing direction changes. FIG. 16 shows the buffer states when the first half-tone processing means 210 starts processing the second image data block. Because processing each image data block starts by using the error values already stored in the error buffers 235a and 235b, the error values are not cleared and good image quality can be achieved. The first half-tone processing means 210 continues writing the results of the processing of the second image data block after the results of the first image data block in the data buffer 236 are written, and the data is output to the command conversion buffer 37 (data output means) when the amount of data stored in the data buffer 236 reaches a predetermined level. Note that the error buffers 235a and 235b are cleared when switched for use in error value calculation.

The error buffers 235a and 235b are thus not cleared when the half-tone process starts (because the leading error values are already stored in the error buffers 235a and 235b when the buffers are switched) in this embodiment of the invention because the half-tone process for calculating error values precedes the normal half-tone process, the resulting leading error values are stored in the appropriate error buffers 235a and 235b, and the normal half-tone process is applied to the image data block using these stored values. More specifically, a drop in print quality resulting from initializing the error buffers 235a and 235b is prevented as a result of the first half-tone processing means 210 starting the half-tone process using the leading error values calculated by the second half-tone processing means 220 (that is, using the leading error values already stored in the error buffers 235a and 235b) by simply switching the error buffer 235a and 235b that is referenced according to the image data block being processed.

The arrangement of the half-tone processing block 200 is also simplified when compared with the first embodiment because there is only one data buffer 236.

Note that while the image data is divided by band unit (the area that can be printed in one pass of the print head) into image data blocks in this example, an image data block can contain multiple bands or even equal to a page unit. More specifically, the image data can be divided into image data blocks of a desired size according to how the data will be used after image processing and the image processing performance of the system. The memory capacity required for the error buffers 235a and 235b can also be reduced with this arrangement because the capacity of the two error buffers 235a and 235b is determined according to the data size of the image data blocks. If the image data block equals a page unit, for example, the buffers must only have enough storage capacity to store the error values for one page, but if a single continuous image can be printed over multiple pages, large capacity error buffers are required.

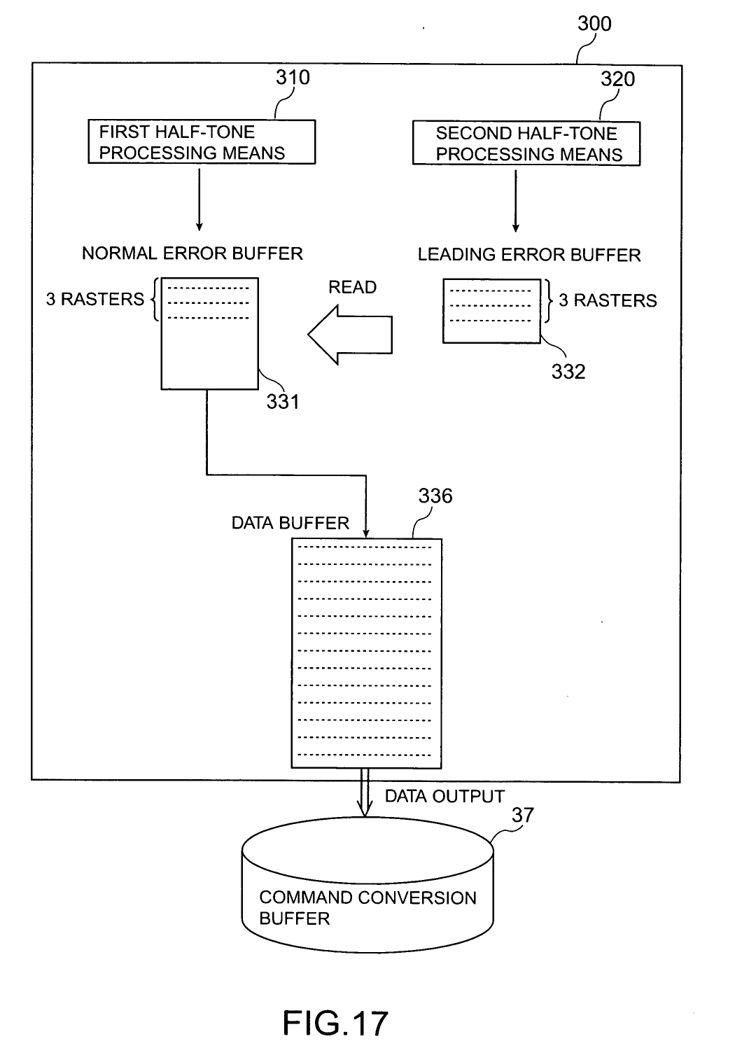

A third embodiment of the invention is described next with reference to FIG. 17. The second embodiment described above has a forward printing pass error buffer 235a (a buffer for storing error values for odd-numbered image data blocks) and a return printing pass error buffer 235b (a buffer for storing error values for even-numbered image data blocks), and switches the error buffers 235a and 235b that are referenced (written) by the first half-tone processing means 210 and second half-tone processing means 220. This third embodiment of the invention differs by having a normal error buffer 331 and a leading error buffer 332, and writing the error values output by a first half-tone processing means 310 to the normal error buffer 331 and writing the error values output by a second half-tone processing means 320 to the leading error buffer 332. Primarily the differences between the second embodiment and this third embodiment of the invention are described below.

As shown in FIG. 17 the half-tone processing block 300 in this embodiment of the invention includes a first half-tone processing means 310 for running the normal half-tone process, a second half-tone processing means 320 for running the half-tone process for error value calculation, a normal error buffer 331, and a leading error buffer 332. As in the second embodiment, the error buffers 331 and 332 can be formed in handles including a color processing LUT and dot generation LUT, or the half-tone processing means 310 and 320 can reference a common color processing LUT and dot generation LUT.

The process run by the half-tone processing block 300 in this embodiment of the invention is described next.

When the half-tone processing block 300 receives the first image data block (forward pass image data) from the color matching process, the first half-tone processing means 310 first runs the normal half-tone process and stores the resulting error values to the normal error buffer 331. The results of the half-tone process run by the first half-tone processing means 310 are written to the data buffer 336.

When the first half-tone processing means 310 starts processing the last three rasters (raster 358) in the first image data block, the second half-tone processing means 320 simultaneously starts the half-tone process to calculate error values for the second image data block. The results from this operation (the leading error values) are stored to the leading error buffer 332, and the result of the half-tone process is stored to another storage area not shown as in the second embodiment.

When the first half-tone processing means 310 finishes processing the first image data block, the normal error buffer 331 is initialized in conjunction with changing the printing direction. The first half-tone processing means 310 also reads and writes the error values for the three rasters already stored in the leading error buffer 332 to the normal error buffer 331, and starts processing the second image data block using these error values. Note that instead of writing the read error values to the normal error buffer 331, the first half-tone processing means 310 can start processing the second image data block by referencing the leading error values stored in the leading error buffer 332. Because the first half-tone processing means 310 thus starts processing each image data block using the leading error values stored in the leading error buffer 332, the half-tone process will not output images with an error value of 0, and good image quality is assured. Note also that because the leading error values stored in the leading error buffer 332 are sequentially overwritten, the leading error buffer 332 is not initialized.

As described above, the leading error values output by the half-tone process for error value calculation are stored in the leading error buffer 332 and the leading error values can be passed so that the normal half-tone process can be started using these leading error values (the half-tone process can be started using the leading error values previously stored in the leading error buffer 332). More specifically, a drop in print quality resulting from normal error buffer 331 initialization can be prevented because half-tone processing the image data blocks can be continued with no interruption in error value continuity. The storage capacity required for the leading error buffer 332 can also be reduced because the leading error buffer 332 only requires sufficient capacity to store error values for three rasters.

As in the second embodiment, the size of the image data blocks can be set as desired according to how the data will be used after image processing and the image processing performance of the system.

The present invention is not limited to the three embodiments described above and can be varied in many ways. For example, the image processing module 26 that runs the color conversion process and the half-tone process is formed in the host computer 20 in the above embodiments (FIG. 1), but the image processing module 26 can instead be rendered in the printer 40 by, for example, rendering the image processing module 26 in the printer firmware.

The invention is also not limited to a printing system 10, and can be used in any system or device that is capable of image processing.

The half-tone process for error value calculation is applied to the three rasters at the leading end part of the each image data block in the above description, but the number of rasters is no so limited and can be set as desired to four, five, or other number. However, this raster count is preferably less than or equal to ten rasters due to control load considerations.

Another preferred aspect of at least one embodiment of the invention additionally has a means for setting the number of rasters for which these error values are calculated, such as a graphic user interface enabling the user to easily set this raster count. This arrangement enables the user to set the number of rasters based on user preference or the type of image data.

The functions of the image processing module 26 described above can also be rendered as a program. This program can be distributed stored on an appropriate data recording medium (not shown in the figure) such as a CD-ROM, flash ROM, a memory card (Compact Flash (R), Smart media, memory stick, or other), Compact Disc media, magneto-optical disc media, DVD media, floppy disk, or hard disk drive.

The invention is also not limited to the printing system 10 and half-tone processing blocks 100, 200, 300 described above, and the arrangement of the devices, system, printing method, and process steps can be varied in many ways without departing from the scope of the accompanying claims. For example, while an inkjet printer is used by way of example above, the invention can be used with other types of printers, including thermal transfer and wire dot impact printing methods. The printing medium is also not limited to slips or sheets, and could be roll paper as well as media other than paper.

Furthermore, discharging ink from the print head 47 to form images on a medium is called “printing” above, but the invention can be applied to form images or patterns on a wide range of recording media whether or not text or images are formed and whether or not what is formed is visible.

In addition, “ink” as used herein refers to a wide range of color-forming agents regardless of type (such as dye-based inks or pigment-based inks).

Although the present invention has been described in connection with the preferred embodiments thereof with reference to the accompanying drawings, it is to be noted that various changes and modifications will be apparent to those skilled in the art. Such changes and modifications are to be understood as included within the scope of the present invention as defined by the appended claims.

What is claimed is:

1. An image processing apparatus comprising:
a first half-tone processing means for dividing image data into n image data blocks (where n is an integer and n≧1) and applying a half-tone process using an error diffusion method to each of the image data blocks;
a second half-tone processing means for executing a half-tone process for error value calculation on a predetermined portion of data at the leading end part of each image data block before processing by the first half-tone processing means;
an odd-numbered error buffer for storing error values generated by the first half-tone processing means from the image data block successively from the leading error values generated by the second half-tone processing means when processing odd-numbered image data blocks;
an even-numbered error buffer for storing error values generated by the first half-tone processing means from the image data block successively from the leading error values generated by the second half-tone processing means when processing even-numbered image data blocks;
an odd-numbered data buffer for storing the result of processing odd-numbered image data blocks by the first half-tone processing means;
an even-numbered data buffer for storing the result of processing even-numbered image data blocks by the first half-tone processing means; and
a data output means for switching and alternately outputting the process results stored in the odd-numbered data buffer and even-numbered data buffer as the processed data after half-tone processing;
wherein the first half-tone processing means starts half-tone processing of the odd-numbered image data blocks and even-numbered image data blocks using the leading error values stored in the odd-numbered error buffer and even-numbered error buffer, respectively.

2. The image processing apparatus described in claim 1, wherein:
the second half-tone processing means applies the half-tone process for error value calculation to a predetermined portion of data at the leading end part of each image data block starting from the second of the n image data blocks when the image data is divided into a plurality of image data blocks.

3. The image processing apparatus described in claim 1 or 2, wherein the image data comprises a plurality of rasters, and the predetermined portion of data at the leading end part of each image data block is the data for ten rasters or less.

4. The image processing apparatus described in any of claims 1 to 2, wherein:
the processed data is data for bidirectional printing; and
the processed data stored in the odd-numbered data buffer is used for printing on the forward pass and the processed data stored in the even-numbered data buffer is used for printing on the return pass.

5. The image processing apparatus described in claim 4, wherein:
the image data contains multiple colors;
the image processing apparatus further comprises a color conversion processing means for applying a color conversion process to the image data to determine the mixing ratio of the plural coloring agents by referencing two color processing lookup tables including a table for forward-pass printing and a table for return-pass printing; and
the color conversion processing means executes the color conversion process by switching the color processing lookup table that is referenced for the odd-numbered image data blocks and the even-numbered image data blocks.

6. A printer driver comprising the means of the image processing apparatus described in any of claims 1 to 2.

7. A printing system comprising:
an image processing apparatus described in claim 4; and
a printer that prints bidirectionally.

8. A program for causing a computer to function as the means of the image processing apparatus described in any of claims 1 to 2.

9. The image processing apparatus described in claim 5, wherein, the second half-tone processing means references the return pass table and simultaneously starts half-tone processing a second image data block when processing of end rasters of a first image data block starts.

10. The image processing apparatus described in claim 9, wherein, once processing of the second image data block starts, half-tone processing of remaining rasters of the first image data block by the first half-tone processing means and half-tone processing of beginning rasters in the second image data block by the second half-tone processing means proceed substantially simultaneously.

11. The image processing apparatus described in claim 10, wherein the first half-tone processing means sequentially half-tone processes the image data blocks, and the second half-tone processing means executes the half-tone process only to calculate the leading error values for a next image data block to be processed by the first half-tone processing means before the first half-tone processing means processes the data.

12. The image processing apparatus described in claim 11 wherein, processing of the end rasters is handled by the first half-tone processing means alone and there is no overlap processing by the second half-tone processing means.

13. An image processing apparatus comprising:
a first half-tone processing means for dividing image data into n image data blocks (where n is an integer and n≧1) and applying a half-tone process using an error diffusion method to each of the image data blocks;
a second half-tone processing means for executing a half-tone process for error value calculation on a predetermined portion of data at the leading end part of each image data block before processing by the first half-tone processing means;
an odd-numbered error buffer for storing error values generated by the first half-tone processing means from the image data block successively from the leading error values generated by the second half-tone processing means when processing odd-numbered image data blocks;
an even-numbered error buffer for storing error values generated by the first half-tone processing means from the image data block successively from the leading error values generated by the second half-tone processing means when processing even-numbered image data blocks;
a data buffer for storing the results of processing image data blocks by the first and second half-tone processing means;
a data output means for switching and alternately outputting the process results stored in the odd-numbered data buffer and even-numbered data buffer as the processed data after half-tone processing;
wherein the first half-tone processing means starts half-tone processing of the odd-numbered image data blocks and even-numbered image data blocks using the leading error values stored in the odd-numbered error buffer and even-numbered error buffer, respectively.

14. An image processing apparatus comprising:
a first half-tone processing means for running a normal half-tone process;
a second half-tone processing means for running a half-tone process for error value calculation;
a normal error buffer;
a leading error buffer;
a data buffer for storing the results of the first half-tone processing means, wherein when the first half-tone processing means starts processing end rasters in a first image block, the second half-tone processing means simultaneously starts the half-tone process to calculate error values for a second image date block.

15. The image processing apparatus described in claim 14, wherein when the first half-tone processing means finishes processing the first image data block, the normal error buffer is initialized in conjunction with changing the printing direction, and the first half-tone processing means reads and writes the error values for rasters already stored in the leading error buffer to the normal error buffer, and starts processing the second image data block using these error values.

16. The image processing apparatus described in claim 1, further including a means for setting the number of rasters for which the error values are calculated.
